(19) United States
(12) Patent Application Publication
(10) Pub. No.: US 2014/0243084 A1
(43) Pub. Date: Aug. 28, 2014

(54) Photo Based Game Development System and Products

(71) Applicant: Lawrence Brennan Davis, Waco, TX (US)

(72) Inventor: Lawrence Brennan Davis, Waco, TX (US)

(21) Appl. No.: 14/184,516

(22) Filed: Feb. 19, 2014

Related U.S. Application Data
(60) Provisional application No. 61/766,347, filed on Feb. 19, 2013.

(51) Int. Cl. A63F 13/00

(52) U.S. Cl. CPC A63F 13/00
USPC 463/31

(57) ABSTRACT

An entertainment, educational and merchandizing method for creating games through computer-based integration of user-uploaded photos and textual information into board and card games that feature such user-uploaded materials, and generate, from administrator-hosted templates, games and entertainment devices involving identification, reference and/or query based-response to such materials.

### CITATION TO PRIOR APPLICATION

This application claims priority of co-pending U.S. Provisional Application No. 61/766,347, filed 19 Feb. 2013.

### BACKGROUND OF THE INVENTION

1. Field of The Invention

The present invention relates to methods of entertainment, to the generation of graphic and informational products, and to educational methods.

2. Background Information

Photo sharing, the posting of digital photos online, is currently one of the fast growing markets, increasing from 100,000 to over 2.5 million users since 2010 and is estimated to be in an early stage of growth. Users participate in photo sharing by uploading their personal photos to a secure repository that is accessible from home, work or a mobile device via a personal online account. Photo sharing is typically free to consumers. Firms make money by selling photo-based merchandise such as customized calendars, mugs, cards and prints.

The photo sharing industry is estimated to grow 21% annually to $1.9 billion within five years, including 22% growth in 2012, mostly from an increase in broadband and mobile links that facilitate consumers storing and purchasing photos through sites like Shutterfly and Snapfish. The photo sharing industry is riding the wave of consumer adoption of smartphones with cameras. As of May 2012, 50.4% of U.S. consumers—roughly 160 million people—use a smartphone; and two-thirds of those ages 25 to 34 use them. Worldwide, over a billion people use smartphones. Over 200 million new digital photos are uploaded on Facebook every day; that is, 6 billion per month and over 90 billion in total. However, this market is poised for even higher growth through:

product innovation

increased adoption of digital cameras and more broadband Internet access

viral user adoption of photo sharing and photo-based merchandise.

In sum, analysts predict high growth in the number of photo-sharing consumers worldwide looking to do something with their photo cache. More people will adopt smartphones with cameras. More photos will exist per person. More photo-sharing firms will compete with Facebook and Shutterfly. And more people will consider photo-based merchandise purchases as a retail category.

There are both desires on the part of consumers, as well as corresponding voids in available options or outlets with respect new uses of photos in the burgeoning digital photo-based culture. Compounding this as a foundation for the desirability of an invention such as that disclosed here is the never-ending quest for new forms of entertainment. Further still, there has been substantial growth in the number of people shopping for goods online (as is relevant to the hereafter-described implementation of the present invention). For example, 17 percent of U.S. consumers shopped online on Cyber Monday during the 2012 Christmas season, spending 21 percent more than Cyber Monday 2011. Overall, shoppers spent $202 billion online in 2011, with an expected increase of 62% to $327 billion by 2016. Finally, Americans spend over $750 million on board and card games annually, representing 13% growth in the board game industry from 1998 to present, despite a 13% decrease in overall toy sales during that same period. This growth is significant given that this period was also the nascence of digital gaming.

Despite all of the above, no one thought to tap into the opportunity for board and card games personalized with personal photos.

### SUMMARY OF THE INVENTION

In view of the foregoing, the present invention provides a unique alternative to photo-based calendars, mugs and prints as a use of digital photos, and as an entertainment or even educational process. Through practice of the present invention, users will be able, as never before, to 1) showcase the best of their photo cache; 2) honor and memorialize the current life stage of family and friends; 3) increase meaningful social experiences; 4) give unique, thoughtful and inspiring gifts; and 5) have fun with friends and family.

The products and services of the present invention will be unique in the marketplace. Photo-based merchandisers (referenced above) are the most similar, known participants in photo-based merchandizing. These firms are known to even sell board and card games, but these are devoid of photo-personalization, or any form of customization.

As described with more particularity below, the methods and processes of the present invention involve users uploading digital photos, with server-based systems providing templates for game board designs, playing cards, and the like, with spaces to be populated with photos and associated factual recitations or queries (names, trivia questions, dates, personal taste issues, job descriptions, and so on). Through conventional production methods, customized games are produced, with user-selected photographs and associated information being used as a central feature of games of varying design.

### DETAILED DESCRIPTION OF THE PREFERRED EMBODIMENT

The entertainment and product generation of the present invention involves facilitating users to integrate their personal digital photos into novel games that, in turn, encourage socially meaningful experiences. Users may, for example, personalize each game with photos of friends, family, fellow organizational members, fellow students, or even business colleagues. The games may be tailored with a focus on trivia, for example, related to a single person (such as for a bridal party or birthday, for example), or for multiple members of any group (such as a “get to know your members” event for a college organization, for example).

Users create a game through a host website or app that poses questions to the user and prompts uploading of digital photo(s) of the individual(s) to be featured in the game. The website generates an immediate image of the proposed game and allows further customization, followed by an option to purchase. Users may further personalize their game with more photos and input prior to finalizing and purchasing the game.

Programming of systems for generating questions, receiving and processing uploaded photos, formatting information and photos with respect to a group of templates for game boards and/or game cards (or equivalent items) is within the ordinary skills of anyone involved in related industries.

A game may be personalized by uploading at least one photo per subject to be displayed on the game's packaging, board and/or cards. However, game play itself may also be personalized by choosing at least one of many card deck types (during game play, dice or board squares will determine which card deck is played each round).

The personalized trivia card deck allows users to import trivia questions about the game's subject(s) from our database based on the subjects' demographic profile like gender and age (e.g., “Which television cartoon would Subject X prefer to watch?” for a 6 year old whose name would actually replace the term “Subject X”), or users may create their own trivia questions about the game's subjects. The action card deck allows users to import action cards from our database (e.g., “Show us a hand gesture or facial expression often used by Subject X” for an adult whose name would actually replace the term “Subject X”). The personal photo card deck allows users to upload additional personal photos (e.g., photos from family vacation, childhood, company events, fun with friends, etc.) so that each photo is a single card serving as material for one of many possible photo-based contests (e.g., look at the card for 10 seconds and then write down as many details as possible so that the player with the most details wins that round; write a witty caption for the card so that the player with the wittiest caption wins that round; play a photo card that best matches a descriptive word so that the player with the best match wins that round; tell one truth and one lie about the photo so that the player with the most convincing lie wins that round). Our game personalization process will make game creation easy by giving the user the option of allowing our technology to search their cache of personal photos on their device(s) or on their photo-sharing site account(s) to find the most interesting photos to include in the game (e.g., based on least blurry photos, and diversity of the number people per photo, lighting, color, and focal points).

Two main pieces of technology are involved in practice of the present methods: 1) a server-based shopping interface, through which users provide photo and other inputs, make further customizations and complete a purchase; and 2) server production software and associated physical systems for creating and processing game board, card and box top images for user approval and ultimate printing via, for example a large format printer, supplied with suitable card stock. The server-based systems may be made compatible with third party photo-sharing sites in order to increase integration. All communication between the Shopping Interface and Server will occur through the Internet.

The shopping interface will include features to:

1. Present guided questions (an online “wizard”) to the user to identify game type, occasion, subject information, card decks and photos, and other customization options, etc.

2. Synchronize with The Games™ Server to create game images based on input.

3. Show images of how the game will look provided by The Games™ Server.

4. Provide an easy tool to edit the game, add photos or customize questions and answers.

5. Manage the e-commerce experience to make final purchases.

6. Manage orders after order creation.

The Games™ Server includes features to:

1. Synchronize with the Games Shopping Interface.

2. Create game images to be passed to consumer to review as part of game design.

3. Create hi-resolution game images (stitching) to be sent to the printer for production.

4. Manage a repository of stitch plans and account information.

5. Manage a repository of card deck information including personalized trivia card questions, custom-created questions that are either private or made available to other users, user ratings of game options and questions (social media input), action cards and personal photo contests.

6. Interface with photo sharing sites, if possible.

Users will see the Games Shopping Interface only. However, the Server component manages bigger jobs like photo integration into the game and connects the interface to other applications like photo-sharing sites.

The preferred embodiment of the present system and method involves users accessing the game-creation system through a website. A “wizard” is available in which the user provides inputs about the game (number of people to be featured, occasion, ages, genders, card decks etc.). Then the user selects photos by either connecting to a photo-sharing site of their choice or by selecting from their computer/device. The inputs are sent to the Server, which returns a stack of images to be displayed back to the Shopping Interface for users to see what their game will look like. The possible images are the board, box, cards, etc. that make up the game, immediately integrated with the information and photos entered by the user in the previous step. The user is then given the option to purchase or edit the game. The editor allows changes such as color changes, question personalization, answer personalization, and photo changes. The remaining purchase process is a standard e-commerce checkout process. For the option for a physical product, the game is sent in the mail to the user via the United States Postal Service, FedEx or UPS. Users will have options for expedited creation and delivery service. For the option of a digital product, the game is delivered immediately and digitally online.

The Server includes software processes and a database server that can handle storing images and text from user inputs (for example, a relational database). It stores and serves images uploaded to our site from the users' device(s) and/or photo-sharing site(s). We will connect to photo-sharing sites using those sites' public application programming interface through which users use their won authentication information to access their own personal photo cache. Our server also processes user inputs from the interface to create the personalized game images. For example, it arranges photos, text and tiles on the board for a board game. For cards, it creates images and pulls questions from a question bank according to the demographic of the person, the game's occasion and other user inputs. It also creates box top images showing how the game will look sitting on a flat surface. This may be repeated multiple times as the user makes edits. The server software will be created with an advanced software programming language. The software and hardware are optimized for rapid response time, peak traffic times and scalability.

The database will contain information for making cards for several types of card decks, including potential game questions for the game's cards. The questions will be generated through a crowdsourcing process and through past users opting to make their customized questions available to other users. The personalized trivia card deck requires interesting questions available for multiple demographics. For example, interesting questions that a 5-year old girl can answer about her dad, as well as interesting questions that a dad can answer about the 5-year old girl. In sum, questions must feature a person from each age and gender that could be answered by family members at different life stages. To serve this purpose, each card may contain questions marked according to the profile of the person who picks up the card.

Since a diversity of potential game questions is desired, an administrator may employ crowdsourcing, a process that involves outsourcing tasks to a distributed group of people, typically online. We will do this by contracting with people on a crowdsourcing site like Amazon's Mechanical Turk (MTurk) to create interesting questions. We will then ask a separate crowdsourcing group on MTurk to rate the first crowdsourcing group's questions. We will offer incentives for people in the first crowdsourcing group to create highly rated questions.

After creating a database of questions ready to handle user needs for personalized trivia card decks, the administrator will cause the system to use the top-ranked questions for each demographic profile from the database as default questions when a user first creates a game. However, the system will also allow users to change, create and rate questions, so that our game is interactive with user-generate content and feedback. A user who has already created a game may also give feedback on questions later. Thus, the game improves over time.

The system will also give users the option of using additional personal photos to create game cards. Users would upload any number of photos to be used as cards for a personal photo card deck, with personal photo deck contests using the photo cards. In addition to the personal photo deck contests mentioned in the overview section, the administrator will also seek more personal photo deck contests from the crowdsourcing community. The system will also allow users to change, create and rate personal photo deck contests (to play with a deck of each user's own personal photos cards; note that personal photos themselves will never be shared with other users), so that our game is interactive with user-generate content and feedback. Game player could also simply answer questions about the photos like, “what month and year was this photo taken?” or “who photographed this picture?” or “where was this photo taken?”

Users will have two finishing options. The primary option is a physical game. The secondary option is a digital game, to be played as an app on any digital device like a tablet computer. As the number of people owning tablet devices increases, people become accustomed to playing board and card games together on a tablet device. One benefit to creating a digital game is that photos could be dynamically updated, pulling from the user's photo cache to replenish the card decks with new photos each time the game is played. For physical games, cards could be replenished by purchasing more from our website.

We sell board and card games whose subject(s) can be multi-person or single-person. Some examples of games that users could create include:

Users can create multi-person games for family, friends or colleagues. We describe examples of each below. However, the multi-person game can be generalize to be any collection of people, even beyond those who are family members, friends or colleagues.

We will identify the last name of the family. We have room on the game box or board for photos that are not necessarily a part of game play, too. The board may contain the movement path, which may be shaped in a square, circle or even the first letter of the family's last name. For board games, each square on the board path may be a photo of a family member. There are arrows showing how movement occurs along the path. The game may come with rewards for winning each round's contest such as gold coins (foil covered plastic) or may be based on points.

Game play may be based on a board with card decks or may be based on just a single card deck without a board. The main idea of game play is that players go around the board whose squares and dice determine which card deck is used in the current contest, who will be the judge if the contest requires one, who will be the subject of the contest or trivia question if the contest requires a subject and how each player progresses. For card decks without a board, game play is determined by rules customized for that contest. The use of personal photos to create customizable games using photo-based card decks and/or personalized trivia card decks and/or create a photo-personalized board and box for the game is the proprietary nature of this product, rather than specific rules about the way players make progress in the game.

A variation on the above-described game involves use of a creative name, in lieu of a family name, and friends' photos are uploaded instead of family members. For example, the creative name could be the name of a place the friends hang out or the city they live in or the university they attend. It could also simply be the word “Friends”.

A further variation on the above-described game involves use of a company, organization or department name, in lieu of a family name, and the photos of employee, members, etc. are uploaded instead of family members. As another example, this could also be a game created by a company to create a custom game for employees to learn company culture, history or rules.

A still further variation of the game is for a single person, such as for a birthday, graduation or bachelorette or bachelor party. It could also be for a business, for example one honoring a company officer or someone retiring from the firm.

Card games produced according to the present method would involve one of the card decks, but would not include a game board. There would be no coins, pawns, dice or boards. For example, it might be created for a woman to be played by her friends at her bachelorette party.

Users will be allowed to add questions, edit possible answers and change the look and feel of the board by selecting various color schemes and themes. While some users will not spend the time to take advantage of all customization features, many users will appreciate the ability to customize one or two things beyond the defaults. For example, users may upload more photos to be included on the board, change the board background color or give the board a Western theme.

Another customization possibility is to allow the user to create their own cards. They could create questions and answers unique to each person. As mentioned before, users could also upload photos and answer questions and have contests about the photos.

Users can order replenishment cards with new questions for any game.

Any of the board or card games will be delivered as either a physical game, or as a software application (e.g., a tablet, smart phone, web-based, computer or any digital app).

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An entertainment method comprising the steps of:
configuring a communications, data processing and data storage administration system for prompting users who access said administration system via online access means to upload one ore more digital photos, and to respond to data input queries with responsive textual input, for integrating said one or more digital photos and said textual input with game design templates, and for outputting a composite of said one or more digital photos, said textual input, and said game design templates to printing means for producing game pieces;
uploading one or more of said digital photos;
inputting said responsive textual input;
actuating said administration system; and
actuating said printing means.
providing said game pieces to a user for playing a game.

2. The method of claim 1 wherein said game pieces include a gaming board wherein said gaming board includes a depiction of at least one of said uploaded photos and at least a portion of said textual input.

3. The method of claim 1 wherein said game pieces include a plurality of playing cards, depictions upon at least some of said playing cards including at least one of said uploaded photos and at least a portion of said textual input.

4. The method of claim 1 wherein said game pieces include a plurality of playing cards, depictions upon at least some of said playing cards including at least one of said uploaded photos and at least a portion of said textual input, and a gaming board including a depiction of at least one of said uploaded photos and at least a portion of said textual input.

5. A method for producing customized merchandise comprising the steps of:
configuring a communications, data processing and data storage administration system for prompting users who access said administration system via online access means to upload one ore more digital photos, and to respond to data input queries with responsive textual input, for integrating said one or more digital photos and said textual input with game design templates, and for outputting a composite of said one or more digital photos, said textual input, and said game design templates to printing means for producing game pieces;
uploading one or more of said digital photos;
inputting said responsive textual input;
actuating said administration system; and
actuating said printing means.

6. The method of claim 5 wherein said game pieces include a gaming board wherein said gaming board includes a depiction of at least one of said uploaded photos and at least a portion of said textual input.

7. The method of claim 5 wherein said game pieces include a plurality of playing cards, depictions upon at least some of said playing cards including at least one of said uploaded photos and at least a portion of said textual input.

8. The method of claim 5 wherein said game pieces include a plurality of playing cards, depictions upon at least some of said playing cards including at least one of said uploaded photos and at least a portion of said textual input, and a gaming board including a depiction of at least one of said uploaded photos and at least a portion of said textual input.

9. A gaming product produced through the steps of:
configuring a communications, data processing and data storage administration system for prompting users who access said administration system via online access means to upload one ore more digital photos, and to respond to data input queries with responsive textual input, for integrating said one or more digital photos and said textual input with game design templates, and for outputting a composite of said one or more digital photos, said textual input, and said game design templates to printing means for producing game pieces;
uploading one or more of said digital photos;
inputting said responsive textual input;
actuating said administration system; and
actuating said printing means.

10. The product of claim 9 wherein said game pieces include a gaming board wherein said gaming board includes a depiction of at least one of said uploaded photos and at least a portion of said textual input.

11. The product of claim 9 wherein said game pieces include a plurality of playing cards, depictions upon at least some of said playing cards including at least one of said uploaded photos and at least a portion of said textual input.

12. The product of claim 9 wherein said game pieces include a plurality of playing cards, depictions upon at least some of said playing cards including at least one of said uploaded photos and at least a portion of said textual input, and a gaming board including a depiction of at least one of said uploaded photos and at least a portion of said textual input.
